(19) United States
(12) Patent Application Publication
(10) Pub. No.: US 2011/0014011 A1
(43) Pub. Date: Jan. 20, 2011

(54) DEVICE FOR DEFORMING A BOOK COVER ALIGNED APPROXIMATELY ON A BOOK BLOCK BACK

(75) Inventors: Holger Schilling, Bad Mergentheim (DE); Thomas Friese, Leipzig (DE)

Correspondence Address: LUCAS & MERCANTI, LLP, 475 PARK AVENUE SOUTH, 15TH FLOOR, NEW YORK, NY, 10016, US

(73) Assignee: MULLER MARTINI HOLDING AG, Hergiswil (CH)

(21) Appl. No.: 12/839,700

(22) Filed: Jul. 20, 2010

(30) Foreign Application Priority Data
Jul. 20, 2009 (EP) 09 405 119.0-1251

(51) Int. Cl. B42C 13/00

(52) U.S. Cl. 412/3; 412/17

(57) ABSTRACT

A device for deforming a book back cover aligned approximately uniformly distributed on a book back, possibly a book cover back having a back insert of a horizontally stretched out positionable book cover, composed of a deforming saddle which can be pushed forward onto the downwardly directed inner side of the book cover, wherein the book cover back is producing a rounded portion of the round cover back located opposite the folding rails between two laterally opposing fold shaping rails which produce a rounded portion of the book cover back, wherein the deforming saddle is formed by two laterally downwardly directed saddle blades formed by the saddle blades which lift the book cover back during the deformation, wherein for adjusting the rounding of the book cover back the saddle blades are together pivotably constructed about an axis extending parallel to the book cover back.

### BACKGROUND OF THE INVENTION

1. Field of the Invention

The present invention relates to a device for deforming a book back cover aligned approximately uniformly distributed on a book back, possibly a book cover back having a back insert of a horizontally stretched out positionable book cover, composed of a deforming saddle which can be pushed forward Onto the downwardly directed inner side of the book cover wherein the book cover, back is producing a rounded portion of the round cover back located opposite the folding rails between two laterally opposing fold shaping rails which produce a rounded portion of the book cover back.

2. Description of the Related Art

The industrial book end manufacture of hard cover books takes place predominately on so called book manufacturing trains which are constructed so as to combine a book block with a book cover.

Of significant importance for a high book quality is the deformation of a book cover in the middle portion or the book cover back. This is true equally for rounded as well as for straight book cover backs. Of major importance is a joining of book block and book cover with precise edges for a harmonic connection.

German reference DE 1 436 086 A discloses or describes a suspending device of a device assigned to a book binding machine of the above-described type. The book cover is transferred by a cloture to a deforming station and is at that location positioned for deforming the book cover back. Subsequently, the book cover is preshaped in the back area by a deforming device. In other words, folding rails which separate the book cover backs from the book covers relative to the folding areas, the folding rails are moved during the oppositely directed lifting of the deforming saddle up to at least to the book cover. This procedure is found in DE 198 53 254 A1 wherein a heated die with a surface shape corresponding to the deformation of the book cover back is pressed with the intermediate placement of the book cover back against an elastically deformable support. At the same time, the book cover back is placed into the desired shape. and the fold which are also called hinges are worked until they are articulated. When using heat over the deforming tools, the shaping can be reinforced or made easier. Conventionally, the deforming tools are made available at the machines in commonly used shape-depending radations. They can be used exchangeably when the book back shape changes.

The manual exchange of the deforming tools causes the set-up times for making the machines available longer.

On the other hand, EP 1 350 634 E1 discloses a die for the manufacture of books with rounded backs which is composed of a rectangular frame in which a plurality of the lamellae are arranged next to each other standing upright which are adjustable with respect to the height of the frame, wherein the adjustability of the lamellae makes it possible to manufacture a profile surface formed by the lamella in the form of a radius. This principle leeds in practice to several embodiments for being able to meet the requirements. The minimum thickness of the lamellae cause a step-like approximation to a curvature profile and can lead during the deformation to markings at the book cover backs. Because of their mobility and substantial inertia, the lamellae can only be heated.

### SUMMARY OF THE INVENTION

In accordance with the invention, the above objects are met by forming the deforming saddle by two laterally downwardly directed saddle blades which during deformation are lifted out upwardly, and wherein the rounded portions of the book cover back are always formed together for as to be pivotable about an axis extending parallel to the book cover backs.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE. DRAWING

In the drawing:

FIG. 1 is a cross-sectional view of the device shown in FIG. 2 shown with a maximum position of the rounded portion;

FIG. 2 is a perspective view of a device according to the invention;

FIG. 3 is a cross-sectional view of the device shown in FIG. 4 with a minimum position of the rounded portion;

FIG. 4 is a perspective view of the device shown in FIG. 3; and

FIG. 5 is a perspective view of the device illustrated in FIGS. 1 through 4, particularly a drive configuration of the device.

### DETAILED DESCRIPTION OF THE INVENTION

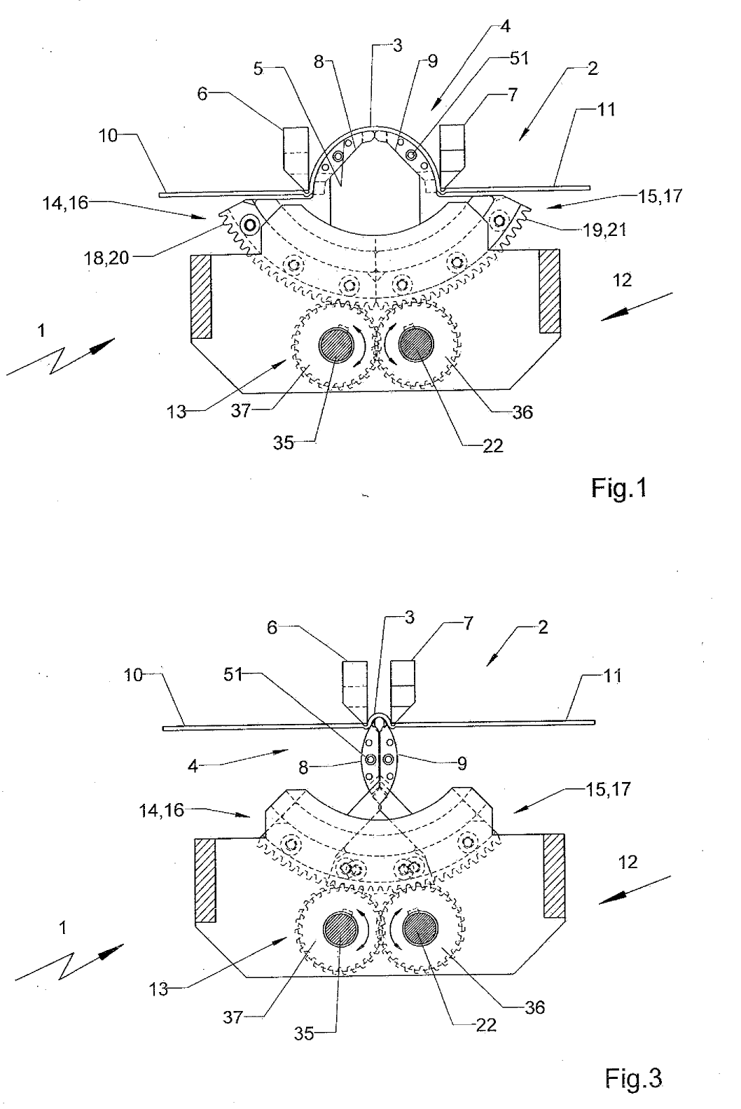

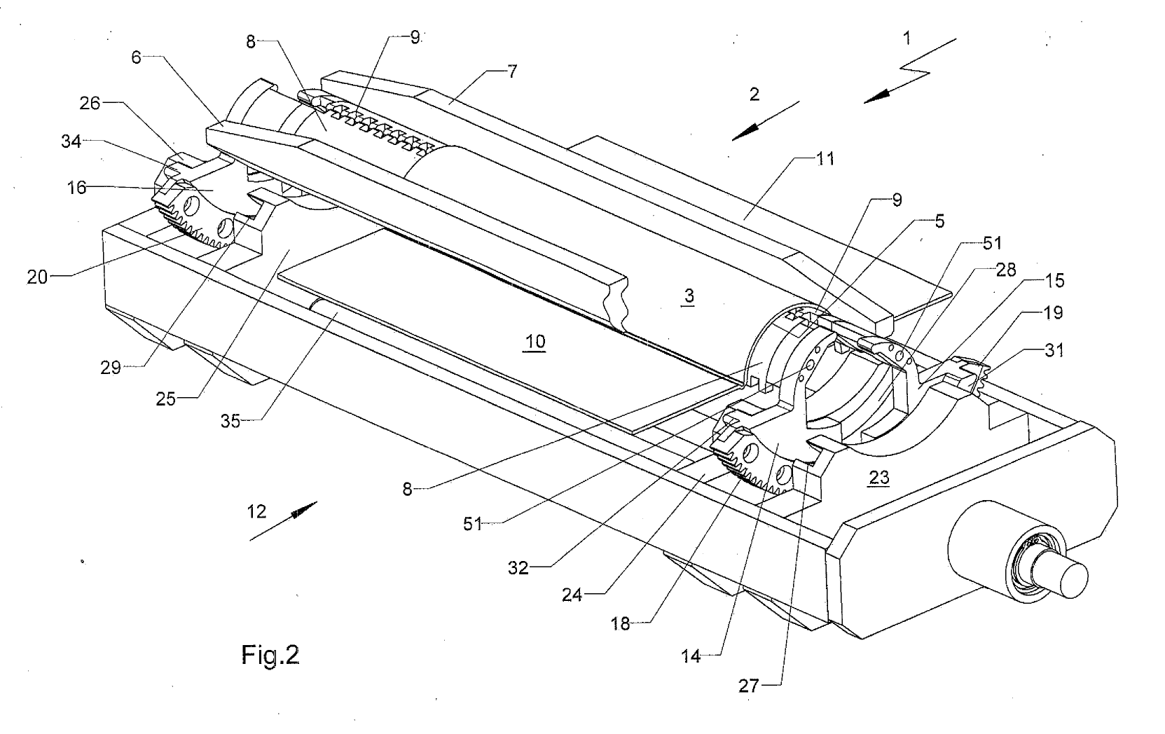

The device 1 illustrated in FIGS. 1 through 5 for deforming a book block back arranged approximately uniformly distributed and aligned, possibly a book back 3 of a book cover 2 which may include a back insert 5, not shown. In Figs. through 4, the book cover 2 is shown after having been positioned with a rounded book cover back 3 prior deformation so as to be stretched out flat. For the purpose of deformation, the device 1 has a deforming saddle 4 which extends perpendicularly of the plane of the drawing of FIGS. 1 and 2 at least over the height of a book cover 2 and forms a rounded or curved surface which is movable toward the downwardly directed inner side 5 of the book cover back 3 at least over the height of a book cover 2 and thereby forms a rounded or curved surface. The book cover back 3 about on the level of the book cover is raisable and lowerable in proximately vertical direction so as to lift out the book cover back 3. GR-81 Continuation

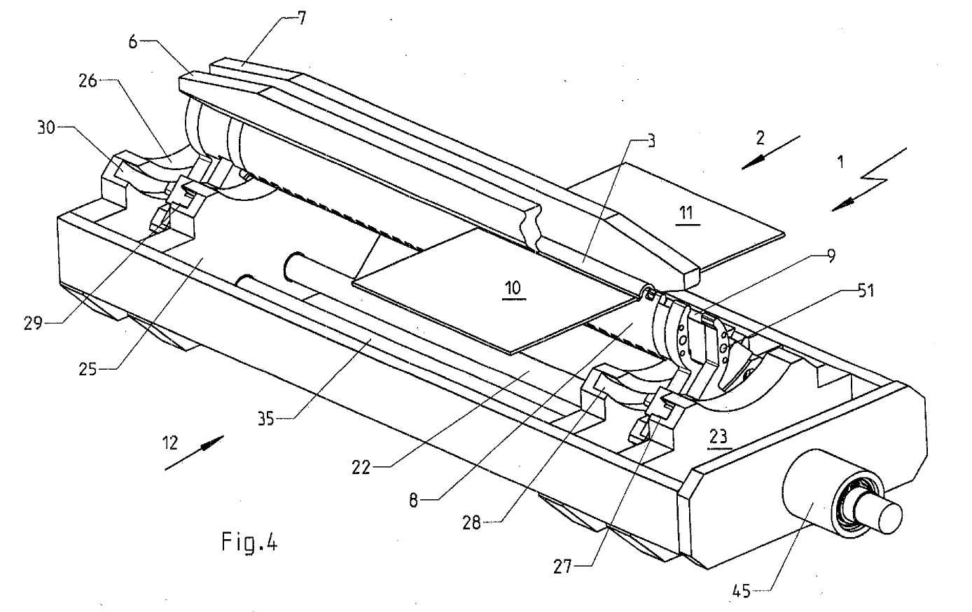

The position in which the deforming saddle 4 is retracted is not illustrated in FIGS. 1 and 2. Approximately on the level of the book cover 2 on both sides of the forwardly pushed or ejected deforming saddle 4, a so-called folding form rail 6, 7, also called folding form ledge, opposes the movement of the deforming saddle 4, where the one book cover 2 is deflected for forming a rounded portion, a fold, or a hinge. The deforming saddle 4 has two laterally downwardly directed saddle blades 8, 9 which lift the book cover back 3 during the deformation out of the flat position, so that it becomes round, which causes the book cover back 3 to be lifted out of the flat position during the deformation, so that the cover 10, 11 of the book cover 2 is pulled inwardly from the initial position by the covers 10, 11 of the book cover 2 hinged to the book cover back 3. For supporting the deformation, the folding ledges or folding rails 7 can be constructed so as to be heatable. The device 1 is distinguished by the fact that the saddle blades 8, 9 of the deforming saddle 4 are adjustable or controllable, so that the latter can be used for any book thickness or book cover. For this purpose, the saddle blades 8, 9 each have a changeably rounded or curved surface, wherein the surfaces when rounded result in a uniform shape of the book cover 3. For this purpose, the saddle blades 8, 9 are constructed so as to be pivotable about an axis extending parallel to the extension of a book block cover or a book cover back 3, so that this pivot axis is preferably located above a book block intended for a book or the extended positioned book cover. The saddle blades 8, 9 form at least during the deformation a closed essentially smooth surface each, so that during the deformation at the book cover back 3 no markings can be created. The downwardly directed ends of the saddle blades 8, 9, which form the folds or hinges of a book cover 2, are movable jointly approximately in the horizontal direction relative to each other and away from each other, so that the deforming saddle 4, as shown in FIGS. 1 and 3, is adjusted for a minimum book thickness with minimum rounding of the book cover back 3.

In FIGS. 1 through 4, in the end face of the deforming saddle 4 facing the drive of the saddle blades 8, 9 of the deforming saddle 4, several ducts 51 are indicated by circles which refer to the heating lines for heating the saddle blades 8, 9 which are primarily electrical heating wires pulled into the ducts 51, installed in the saddle blades 8, 9 and, for example, connected to the drive side of an electrical line so as to be switchable on and off.

For switching on or adjusting the device 1 arranged in a frame 12 a manually or motorically drivable actuating device 13 is intended. The pivoting movement of the saddle blades 8, 9 takes place by means of segment-like drive elements 14, 15, 16, 17 where the saddle blades 8, 9 of the deforming saddle 4 are respectively fastened. The approximately quarter circle-shaped drive elements 14, 15, 16, 17 have at the circumference thereof a gear ring 18, 19, 20, 21 and are pivotably mounted in bearing shields 23, 24, 25, 26 of the frame 12. The bearing shields 23 through 26 are arranged in pairs in the end region of the deforming saddle 4 at the frame 12 and are assigned to a respective drive element 14. The drive elements 14, 15, 16 and 17 are supported between two bearing shields 23, 24, 25, 26 which have circle-shaped guide tracks 27, 28, 29, 30 in relation to one of the saddle plates 8, 9 for the pivoting axes of the saddle blades 8, 9. A saddle beam 31 through 34 each fastened to the drive elements 14 to 17 slides in the circular guide track 27, 28, 29, 30.

The guide track 27 through 31 constructed in accordance with a portion of a circular path is arranged concentrically the pivoting axis of the saddle blades 8, 9 which preferably is located in a plane extending perpendicularly of the book cover 2 and through book cover back 8 or book block back.

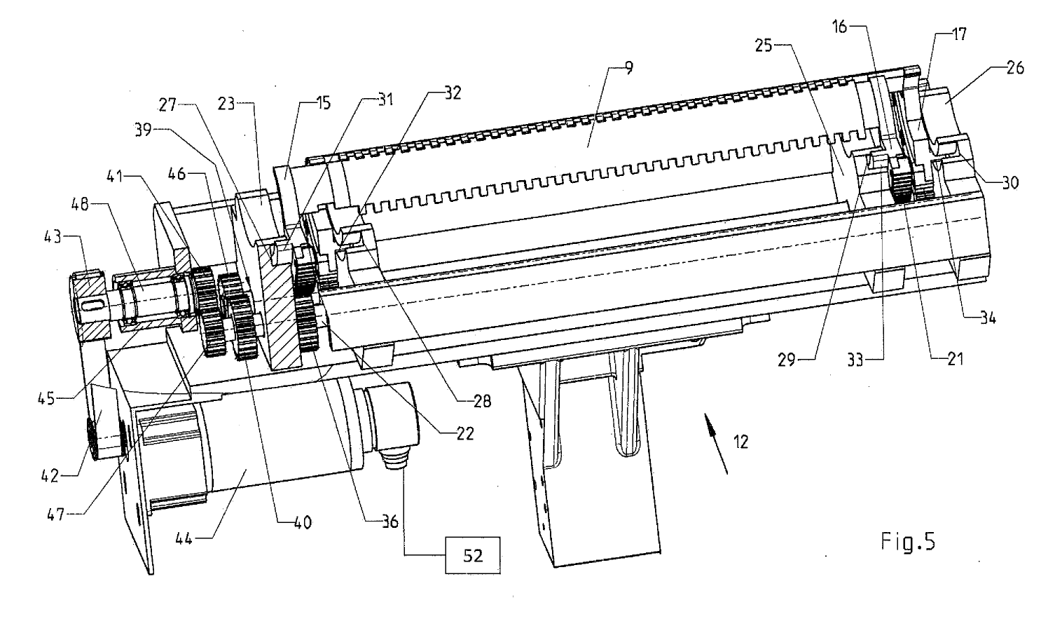

The drive elements 14, 15 and 16, 17 arranged in pairs in one end of the device 1 and the frame 12 or the deforming saddle 4, supported between two bearing shields 23, 24 and 25, are each connected to a drive shaft 22 and 35, in the present case indirectly, and are at least supported in one of the bearing shields 23, 24 and 25, 26 arranged in pairs at the ends of the device, see particularly FIGS. 2, 4 and 5. At the drive end and also at the opposite end of the device 1 are fastened at the drive shafts 22, 35 always two gears 36, 37 which mesh with the gear rings of the corresponding drive elements 14, 16 and 15, 17, see (FIG. 5). Moreover, on the drive side of the device, on which on the side facing away from the device 1 at the ends of the drive shafts 22, 35 a further gear ring 40 or 46 is fastened, wherein the gear pinions mesh with each other and the two drive shafts 22, 35 rotate in opposite directions, so that also the assigned drive elements 14, 15 and 16, 17 move away from each other during a change of direction of the gear pinion 40, 46. The drive of the gear pinion 40, 46 takes place through another gear 47 which is seated on one or another drive shaft 22, 25, in the present case the drive shaft 22, which meshes with one drive wheel 41 fastened at an intermediate shaft 48 mounted in a housing 45 fastened to the frame 12, wherein the intermediate shaft 48 is connected for being driven through a belt disk 43 with an angle of rotation-controlled electro motor 44, see FIG. 5.

Alternatively, the drive of the device 1 or the saddle blades 8, 9 could take place through a drive shaft 22 or 35 in which is fastened a gear 36 or 37 each which is intended for driving the drive elements 14, 15 and 16, 17. This gear 36 or 37, respectively, transmits its rotation to the gear ring 19 or 18 of the drive element 15 or 14 and a gear assigned to the drive element 14, 16, not shown, which is seated on a shaft arranged between the bearing shield pairs and mounted thereon. This shaft is not visible. The shaft meshes with the two rings 18, 20 of the drive elements 14 and 16. The drive of the drive shaft 22 or 35 takes place through an intermediate shaft 29 which is composed of a gear pinion 40 seated on a drive shaft end and attached at the head to the frame 12, wherein the gear pinion 41 is driven by a drive belt 42 through a belt wheel 43 by an electric motor 44, preferably an angle of rotation controllable motor.

In accordance with a second alternative embodiment of the drive of the device 1, in contrast to the above-described alternative embodiment of the drive of the device 1, the electric motor 44 could be directly connected through the intermediate shaft to the drive shaft 22 or 35.

FIG. 1 of the drawing shows the device 1 in the disengaged position of the deforming saddle 40 for a maximum rounding of the book cover back 3 between the fold form rails 6, 7; for this purpose, the drive elements 14, 15 and 16, 17 are pivoted away from each other by means of the gears 36, 37, so that their inner limiting surfaces contact each other approximately in a common vertical plane.

FIG. 3 shows the device 1 in the released position of the deforming saddle 4 for a minimum rounding of the book cover back 3 in a thin book, wherein the drive elements 14, 15 and 16, 17 are partially pivoted above each other or are partially offset relative to each other.

The adjustment of the deforming saddle 4 could not only take place in a position of rest but also during a forward pushing or return movement.

In order to create an essentially smooth forward pushing surface on the highest circumferential line of the deforming saddle 4, with an essentially step-free transition, the pushing ends of the saddle blades 8, 9 are constructed so as to engage in each other in the manner of a rake. This constructive measure is illustrated in the perspective views of FIGS. 2, 4 and 5. In order to be able to further optimize a minimum deforming saddle 4 by means of the device 1, the lower end of the saddle blades 8, 9 are also constructed with gear wheels 49, 59 which engage in each other in the manner of a rake, so that the saddle blades 8, 9 which have an approximately half-moon shaped cross-section can be placed in each other without a gap with a minimum rounding of the book cover back 3, as shown in FIGS. 3 through 5.

Also, FIG. 2 shows the device in a position corresponding to FIG. 1 with a larger book cover 2, while FIG. 4 shows the device with a smaller book cover 2 in accordance with FIG. 3.

Of course, it is possible and is within the skill of an expert, to modify the device 1 with other embodiments of a drive or gear system as compared to those explained above.

The present device 1 has been found to be particularly advantageous if a continuously carried out processing or binding order of books having different thicknesses is carried out, so that the book cover back profile must be changed during the work process. A change of the rounding of the book cover back 3 can be carried out during a work process which is taking place by means of a control acting on the drive of the device 1 for adjusting or controlling the device 1, wherein a control device usable for this purpose is to be connected to an electronic processing program.

We claim:

1. A device for deforming a book back cover aligned approximately uniformly distributed on a book back, possibly a book cover back having a back insert of a horizontally stretched out positionable book cover, composed of a deforming saddle which can be pushed forward onto the downwardly directed inner side of the book cover, wherein the book cover back is producing a rounded portion of the round cover back located opposite the folding rails between two laterally opposing fold shaping rails which produce a rounded portion of the book cover back, wherein the deforming saddle is formed by two laterally downwardly directed saddle blades formed by the saddle blades which lift the book cover back during the deformation, wherein for adjusting the rounding of the book cover back the saddle blades are together pivotably constructed about an axis extending parallel to the book cover back.

2. The device according to claim 1, wherein the saddle blades are mounted by means of drive elements each in a guide track concentrically of the pivoting axis in a circular section in a bearing shield of a frame.

3. The device according to claim 2, wherein the pivoting axis of the saddle blades is located in a plane extending perpendicularly of the book cover and determinable by a longitudinal middle axis extending through the book cover back.

4. The device according to claim 2, wherein the saddle blades are each attached to the drive elements connected to the segment-like drive elements engaging by means of guide beams in the guide tracks, wherein the drive element has at a circumference thereof a toothed ring.

5. The device according to claim 4, wherein the ends of the saddle blades at the front ends of the guide track and the guide beams form a guide device.

6. The device according to claim 4, wherein the drive elements are each connected to a gear for driving with a common drive shaft.

7. The device according to claim 2, wherein at an end of the saddle blades of the deforming saddle are arranged guide devices between two bearing shields in which frame the two bearing shields are arranged one after the other along the drive shaft.

8. The device according to claim 1, wherein the saddle blades have heating ducts extending parallel to the pivoting axis.

9. The device according to claim 1, wherein the saddle blades forming the surface of the deforming saddle are constructed so as to engage into each other at the facing free ends in the manner of a rake.

10. The device according to claim 1, wherein the saddle blades are comprised at the downwardly projecting ends of toothed rails which engage into each other in a rake-like manner.

11. The device according to claim 1, wherein the device is connected for actuation to a programmable control.

12. A method of manufacturing books formed of book blocks suspended from a book cover, the method comprising deforming a book back cover aligned approximately uniformly distributed on a book back, possibly a book cover back having a back insert of a horizontally stretched out positionable book cover, composed of a deforming saddle which can be pushed forward onto the downwardly directed inner side of the book cover, wherein the book cover back is producing a rounded portion of the round cover back located opposite the folding rails between two laterally opposing fold shaping rails which produce a rounded portion of the book cover back, wherein the deforming saddle is formed by two laterally downwardly directed saddle blades formed by the saddle blades which lift the book cover back during the deformation, wherein for adjusting the rounding of the book cover back the saddle blades are together pivotably constructed about an axis extending parallel to the book cover back.
